(19) United States
(12) Patent Application Publication
(10) Pub. No.: US 2021/0248390 A1
(43) Pub. Date: Aug. 12, 2021

(54) ROAD MARKING RECOGNITION METHOD, MAP GENERATION METHOD, AND RELATED PRODUCTS

(71) Applicant: Shenzhen Sensetime Technology Co., Ltd., Shenzhen (CN)

(72) Inventors: Bojun LIANG, Shenzhen (CN); Jiaxuan ZHANG, Shenzhen (CN); Zhe WANG, Shenzhen (CN)

(73) Assignee: Shenzhen Sensetime Technology Co., Ltd., Shenzhen (CN)

(21) Appl. No.: 17/138,873

(22) Filed: Dec. 30, 2020

Related U.S. Application Data
(63) Continuation of application No. PCT/CN20/74478, filed on Feb. 7, 2020.

(51) Int. Cl. G06K 9/00; G06K 9/46; G06N 3/08; G09B 29/10

(52) U.S. Cl. CPC G06K 9/00798; G09B 29/106; G06N 3/08; G06K 9/4642

(57) ABSTRACT

Embodiments of the application disclose a road marking recognition method, a map generation method, and related products. The road marking recognition method includes that: a base map of a road is determined according to acquired point cloud data of the road, pixels in the base map being determined according to reflectivity information of an acquired point cloud and position information of the point cloud; a pixel set composed of the pixels in the base map that road markings include is determined according to the base map; and at least one road marking is determined according to the determined pixel.

### CROSS-REFERENCE TO RELATED APPLICATION

This application is a continuation under 35 U.S.C. § 120 of International Application No. PCT/CN2020/074478, filed on Feb. 7, 2020, the entire disclosure of which is hereby incorporated by reference in its entirety.

### TECHNICAL FIELD

The application relates to the field of image recognition, in particular to a road marking recognition method, a map generation method, and related products.

### BACKGROUND

A high precision map is an important part of intelligent driving. In order to realize high precision positioning during driving, autonomous vehicles need to rely on the support of a high precision map. For the construction of a high precision map, the extraction of road markings, including lane lines, stop lines, and zebra crossings, is extremely important. Currently, vehicle cameras, laser radar, satellite images, and aerial photography are mainly used to acquire map data, and the acquired map data is used to construct the high precision map. The three-dimensional (3D) point cloud data obtained by the laser radar has characteristics of high precision and obvious reflectance of road marking, which is a main method to construct the high precision map. The road marking is marked by performing 3D scene reconstruction to the 3D point cloud data and then converting it into a two-dimensional (2D) grid map.

At present, when the road marking is marked, each road marking in the whole map needs to be recognized either manually or by setting multiple thresholds. Therefore, the process of marking the road markings in the high precision maps is cumbersome, and the marking of road markings through the thresholds will lead to a low marking accuracy.

### SUMMARY

Embodiments of the application provide a road marking recognition method, a map generation method, and related products to improve the accuracy of recognizing road markings in a map.

In a first aspect, the embodiments of the application provide a road marking recognition method, which may include:

a base map of a road is determined according to acquired point cloud data of the road, pixels in the base map being determined according to reflectivity information of an acquired point cloud and position information of the point cloud;

a pixel set composed of the pixels in the base map that road markings include is determined according to the base map; and

at least one road marking is determined according to the determined pixel set.

In a possible implementation mode, before the pixel set composed of the pixels in the base map that road markings include is determined according to the base map, the method may further include:

the base map of the road is segmented into multiple block base maps according to a topological line of the road.

That the pixel set composed of the pixels in the base map that road markings include is determined according to the base map may include:

the pixel set composed of the pixels in each block base map that road markings include is determined according to the block base map.

In a possible implementation mode, that the pixel set composed of the pixels in each block base map that road markings include is determined according to the block base map may include:

each block base map is rotated respectively; and

the pixel set composed of the pixels in each un-rotated block base map that road markings include is determined according to each rotated block base map.

In a possible implementation mode, that the base map of the road is segmented into multiple block base maps according to the topological line of the road may include:

the topological line of the road is determined according to a moving track of a device that acquires the point cloud data of the road; and

the base map of the road is equidistantly segmented into image blocks along the topological line of the road, and multiple block base maps are obtained. Two adjacent block base maps in the base map of the road have an overlapping part, a segmentation line along which the base map of the road is segmented is perpendicular to the topological line of the road, and the parts, at two sides of the topological line of the road, of each block base map have the equal width.

In a possible implementation mode, that at least one road marking is determined according to the determined pixel set may include:

the pixel sets composed of the pixels in the adjacent block base maps with the same pixels are merged to obtain a merged pixel set. When the same pixel has multiple probabilities in the merged pixel set, the average of multiple probabilities of the same pixel is assigned as the probability of the pixel; and

at least one road marking is determined according to the merged pixel set.

In a possible implementation mode, that each block base map is rotated respectively may include:

a transformation matrix corresponding to each block base map is determined according to an included angle between the segmentation line of each block base map and the horizontal direction; and

according to the transformation matrix corresponding to each block base map, each block base map is rotated until its segmentation line is consistent with the horizontal direction, the segmentation line of a block base map being a straight line along which the block base map is segmented from the base map of the road.

That the pixel set composed of the pixels in each un-rotated block base map that road markings include is determined according to each rotated block base map may include:

an initial pixel set composed of the pixels in the rotated block base map that road markings include is determined according to each rotated block base map; and

according to an inverse matrix of the transformation matrix corresponding to each un-rotated block base map, the pixels in each rotated block base map that road markings include are transformed to obtain the pixel set composed of the pixels in each un-rotated block base map that road markings include.

In a possible implementation mode, that the pixel set composed of the pixels in each block base map that road markings include is determined according to the block base map may include:

the probability that each pixel in each block base map belongs to the road marking is determined according to a feature map of each block base map;

according to the feature map of each block base map, a n-dimensional feature vector of each pixel whose probability is greater than a preset probability value in each block base map is determined; and

according to the n-dimensional feature vector of each pixel whose probability is greater than the preset probability value in the feature map of each block base map, each pixel whose probability is greater than the preset probability value is clustered to obtain the pixel sets corresponding to different road markings in each block base map.

That the pixel sets composed of the pixels in the adjacent block base maps with the same pixels are merged to obtain the merged pixel set may include:

when the pixel sets corresponding to the same road marking in the adjacent block base maps have the same pixels, the pixel sets corresponding to the same road marking in the adjacent block base maps are merged to obtain the pixel sets corresponding to the different road markings in the base map of the road.

That at least one road marking is determined according to the merged pixel set may include:

each road marking is determined according to the pixel set corresponding to each road marking.

In a possible implementation mode, that each road marking is determined according to the pixel set corresponding to each road marking may include:

for a road marking, a key point that corresponds to the pixel set corresponding to the road marking is determined according to the pixel set corresponding to the road marking; and

the road marking is fitted based on the determined key point.

In a possible implementation mode, that the key point that corresponds to the pixel set corresponding to the road marking is determined according to the pixel set corresponding to the road marking may include:

a main direction of a first set is determined by taking the pixel set corresponding to the road marking as the first set;

a rotation matrix is determined according to the determined main direction of the first set;

according to the determined rotation matrix, the pixels in the first set are transformed, so that the main direction of the first set after the pixel is transformed is the horizontal direction; and

multiple key points are determined according to the first set whose main direction is transformed.

That the road marking is fitted based on the determined key point may include:

the determined multiple key points are transformed based on the inverse matrix of the rotation matrix;

a line segment corresponding to the first set is fitted based on the transformed multiple key points; and

the line segment corresponding to the first set is assigned as the road marking.

In a possible implementation mode, when there are multiple pixel sets corresponding to a road marking, one of the pixel sets corresponding to the road marking is assigned as the first set, and the fitted line segments corresponding the first sets are not connected, the method may further include:

If there are unconnected line segments in the line segments corresponding to the first sets, when the distance between two endpoints with the smallest distance in unconnected two line segments is less than a distance threshold, and the endpoints of the unconnected two line segments are collinear, the unconnected two line segments are connected to obtain a spliced line segment; and

the spliced line segment is assigned as the road marking.

In a possible implementation mode, that multiple key points are determined according to the first set whose main direction is transformed may include:

the first set whose main direction is transformed is assigned as a set to be processed;

the leftmost pixel and the rightmost pixel in the set to be processed are determined;

when an interval length is less than or equal to a first threshold and an average distance is less than a second threshold, a key point is determined based on the leftmost pixel, and a key point is determined based on the rightmost pixel, the average distance being an average of distances between the pixels in the set to be processed and the line segment formed by the leftmost pixel and the rightmost pixel, and the interval length being the difference between the abscissa of the rightmost pixel and the abscissa of the leftmost pixel in the set to be processed; and

when the interval length is less than or equal to the first threshold, and the average distance is greater than the second threshold, the pixels in the set to be processed are discarded.

In a possible implementation mode, the method may further include:

when the interval length is greater than the first threshold, the average of the abscissas of the pixels in the set to be processed is assigned as a segment coordinate, the set composed of the pixels, whose abscissas are less than or equal to the segment coordinate, in the set to be processed is assigned as a first subset, the set composed of the pixels, whose abscissas are greater than or equal to the segment coordinate, in the set to be processed is assigned as a second subset, and taking the first subset and the second subset respectively as the set to be processed, the step of processing the set to be processed is performed.

In a possible implementation mode, that the base map of the road is determined according to the acquired point cloud data of the road may include:

a non-road point cloud is recognized and removed from the acquired point cloud data of the road, and preprocessed point cloud data is obtained;

according to an attitude of the device that acquires the point cloud data of the road, the preprocessed point cloud data of each frame is transformed into the world coordinate system, and the transformed point cloud data of each frame is obtained;

the transformed point cloud data of each frame is spliced to obtain the spliced point cloud data;

the spliced point cloud data is projected to a set plane, the set plane being provided with grids divided according to a fixed length-width resolution, and each grid corresponding to a pixel in the base map of the road; and

for a grid in the set plane, a pixel value of the pixel in the base map of the road corresponding to the grid is determined according to the average reflectivity of the point cloud projected to the grid.

In a possible implementation mode, that for a grid in the set plane, the pixel value of the pixel in the base map of the road corresponding to the grid is determined according to the average reflectivity of the point cloud projected to the grid may include:

for a grid in the set plane, the pixel value of the pixel in the base map of the road corresponding to the grid is determined according to the average reflectivity and the average height of the point cloud projected to the grid.

In a possible implementation mode, after the preprocessed point cloud data is obtained, the method may further include:

according to an external reference of the device that acquires the point cloud data of the road to the device that acquires an image of the road, the preprocessed point cloud data is projected onto the acquired image of the road, and colors corresponding to the preprocessed point cloud data are obtained.

That for a grid in the set plane, the pixel value of the pixel in the base map of the road corresponding to the grid is determined according to the average reflectivity of the point cloud projected to the grid may include:

for a grid in the set plane, the pixel value of the pixel in the base map of the road corresponding to the grid is determined according to the average reflectivity of the point cloud projected to the grid and the average color corresponding to the point cloud projected to the grid.

In a possible implementation mode, that the pixel set composed of the pixels in the base map that road markings include is determined according to the base map is to performed by a neural network. The neural network is obtained by training with a sample base map marked with the road marking.

In a possible implementation mode, the neural network is trained by the following steps:

features of a sample block base map are extracted by using the neural network to obtain the feature map of the sample block base map;

the probability that each pixel in the sample block base map belongs to the road marking is determined based on the feature map of the sample block base map;

the n-dimensional feature vector of each pixel whose probability is greater than the preset probability value in the sample block base map is determined according to the feature map of the sample block base map. The n-dimensional feature vector is used to represent an instance feature of the road marking, and n is an integer greater than 1;

the pixels whose probability is greater than the preset probability value in the sample block base map are clustered according to the determined n-dimensional feature vector of the pixel, and the pixels belonging to the same road marking in the sample block base map are determined; and

a network parameter value of the neural network is adjusted according to the determined pixels belonging to each road marking in the sample block base map and the road marking marked in the sample block base map.

In a possible implementation mode, the method may further include:

a marked distance of a first pixel in the sample block base map is determined, the first pixel being any pixel in the sample block base map, the marked distance of the first pixel being the distance between the first pixel and a second pixel, the second pixel being the pixel with the minimum distance from the first pixel in the pixels that are in the road marking marked in the sample block base map;

that the network parameter value of the neural network is adjusted according to the determined pixels belonging to each road marking in the sample block base map and the road marking marked in the sample block base map may include:

the network parameter value of the neural network is adjusted according to the determined pixels belonging to each road marking in the sample block base map, the road marking marked in the sample block base map, the marked distance of the first pixel in the sample block base map and a predicted distance of the first pixel in the sample block base map; and

the predicted distance of the first pixel is the distance between the first pixel and a third pixel, and the third pixel is the pixel with the minimum distance from the first pixel in the determined pixels belonging to each road marking in the sample block base map.

In a possible implementation mode, the method may further include:

a marked direction of a fourth pixel in the sample block base map is determined, the fourth pixel being any pixel in the sample block base map, the marked direction of the fourth pixel being a tangent direction of a fifth pixel, the fifth pixel being the pixel with the minimum distance from the fourth pixel in the pixels that are in the road marking marked in the sample block base map;

that the network parameter value of the neural network is adjusted according to the determined pixels belonging to each road marking in the sample block base map and the road marking marked in the sample block base map may include:

the network parameter value of the neural network is adjusted according to the determined pixels belonging to each road marking in the sample block base map, the road marking marked in the sample block base map, the marked direction of the fourth pixel in the sample block base map, and a predicted direction of the fourth pixel in the sample block base map; and

the predicted direction of the fourth pixel is the tangent direction of a sixth pixel, and the sixth pixel is the pixel with the minimum distance from the fourth pixel in the determined pixels belonging to each road marking in the sample block base map.

In a second aspect, the embodiments of the application provide a map generation method, which may include:

any road marking recognition method in the first aspect is used to determine at least one road marking on a road according to the point cloud data of the road which is acquired by an intelligent driving device; and

a map including at least one road marking on the road is generated according to at least one road marking on the road.

In a possible implementation mode, the method may further include:

the generated map is corrected, and a corrected map is obtained.

In a possible implementation mode, the at least one road marking is determined by a neural network. After the map is generated, the method may further include:

the neural network is trained by using the generated map.

In a third aspect, an electronic device is provided. The electronic device includes at least one processor and a non-transitory computer readable storage. The computer readable storage is coupled to the at least one processor and stores at least one computer executable instruction thereon which, when executed by the at least one processor, causes the at least one processor to perform the method of the first aspect.

In a fourth aspect, a map generation apparatus is provided. The map generation apparatus includes at least one processor and a non-transitory computer readable storage. The computer readable storage is coupled to the at least one processor and stores at least one computer executable instruction thereon which, when executed by the at least one processor, causes the at least one processor to use the method in the first aspect to determine at least one road marking on a road according to point cloud data of the road which is acquired by an intelligent driving device; generate a map including the at least one road marking on the road according to the at least one road marking on the road; correct the generated map and obtain a corrected map. The at least one road marking is determined by a neural network. The at least one computer executable instruction when executed by the at least one processor, further causes the at least one processor to train the neural network by using the generated map after generating the map.

In a fifth aspect, an intelligent driving device is provided. The intelligent driving device includes the map generation apparatus in the fourth aspect and a main body of the intelligent driving device.

In a sixth aspect, a non-transitory computer readable storage medium is provided. The non-transitory computer readable storage medium stores computer programs which, when executed by a processor, cause the processor to: determine a base map of a road according to acquired point cloud data of the road, pixels in the base map being determined according to reflectivity information of an acquired point cloud and position information of the point cloud; determine a pixel set composed of the pixels in the base map that road markings include according to the base map; determine at least one road marking according to the determined pixel set.

### BRIEF DESCRIPTION OF THE DRAWINGS

FIG. 1 is a flowchart of a road marking recognition method provided by an embodiment of the application.

FIG. 2 is a schematic diagram of segmenting a base map of a road according to an embodiment of the application.

FIG. 3 is a schematic diagram of rotating a block base map according to an embodiment of the application.

FIG. 4 is a schematic diagram of merging adjacent block base maps according to an embodiment of the application.

FIG. 5 is a schematic diagram of fitting a road marking according to an embodiment of the application.

FIG. 6 is a schematic diagram of discarding a pixel set according to an embodiment of the application.

FIG. 7 is a flowchart of a neural network training method provided by an embodiment of the application.

FIG. 8 is a flowchart of a map generation method provided by an embodiment of the application.

FIG. 9 is a structural schematic diagram of a road marking recognition apparatus provided by an embodiment of the application.

FIG. 10 is a structural schematic diagram of a map generation apparatus provided by an embodiment of the application.

FIG. 11 is a block diagram of function units of a road marking recognition apparatus provided by an embodiment of the application.

FIG. 12 is a block diagram of function units of a map generation apparatus provided by an embodiment of the application.

### DETAILED DESCRIPTION OF THE EMBODIMENTS

The technical solutions in the embodiments of the application will be described clearly and completely below in combination with the drawings in the embodiments of the application. It is apparent that the described embodiments are not all embodiments but part of the embodiments of the application. All other embodiments obtained by those of ordinary skill in the art based on the embodiments in the application without creative work shall fall within the scope of protection of the application.

The specification and claims of the application and terms “first”, “second”, “third”, “fourth”, etc. in the drawings are used for distinguishing different objects rather than describing a specific sequence. In addition, terms “include” and “have” and any transformations thereof are intended to cover nonexclusive inclusions. For example, a process, method, system, product or device including a series of steps or units is not limited to the steps or units which have been listed but optionally further includes steps or units which are not listed or optionally further includes other steps or units intrinsic to the process, the method, the product or the device.

“Embodiment” mentioned herein means that a specific feature, result or characteristic described in combination with an embodiment may be included in at least one embodiment of the application. Each position where this phrase appears in the specification does not always refer to the same embodiment as well as an independent or alternative embodiment mutually exclusive to another embodiment. It is explicitly and implicitly understood by those of ordinary skill in the art that the embodiments described in the disclosure may be combined with other embodiments.

First, it is to be noted that the road markings mentioned in the application include but are not limited to, lane lines, zebra crossings, and stop lines on the road. For a road marking, the application takes the lane line as an example to illustrate.

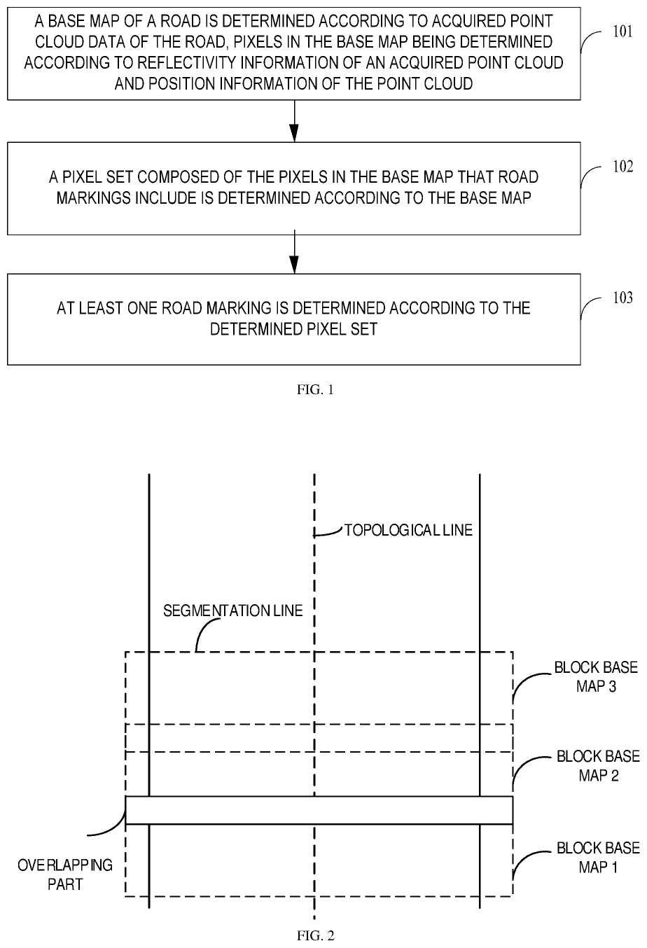

With reference to FIG. 1 which is a flowchart of a road marking recognition method provided by an embodiment of the application, the method is applied to a road marking recognition apparatus. The method of the present embodiment includes the following steps.

At S101, a base map of a road is determined according to acquired point cloud data of the road, and pixels in the base map are determined according to reflectivity information of an acquired point cloud and position information of the point cloud.

The point cloud data of the road includes multi-frame point cloud data. The multi-frame point cloud data is acquired by an acquisition device (for example, a device with a laser radar) driving on the road. Therefore, the acquired point cloud data of each frame may include a non-road point cloud. For example, the acquired point cloud data may contain the point clouds corresponding to pedestrians, vehicles, obstacles, etc. Therefore, non-road point cloud data is first recognized and removed from the point cloud data of each frame, and preprocessed point cloud data of each frame is obtained. The non-road point cloud may be recognized and removed through a trained deep learning model, which is not described in detail in the application.

The preprocessed point cloud data of each frame is transformed to the world coordinate system to obtain the transformed point cloud data of each frame. That is, an attitude (coordinate) of the acquisition device when acquiring the point cloud data of each frame is obtained, and a transformation matrix required for transforming the attitude to the world coordinate system is determined; then, the transformation matrix is used to transform the point cloud data of each frame to the world coordinate system to obtain the transformed point cloud data of each frame.

Further, the transformed point cloud data of each frame is spliced to obtain the spliced point cloud data. Splicing is mainly to splice the sparse point cloud data of each frame into dense point cloud data. The spliced point cloud data is projected to a set plane. The set plane includes multiple grids divided according to a fixed length-width resolution, for example, the length-width resolution may be 6.25 cm×6.25 cm. For a grid in the set plane, one or more point cloud in the spliced point cloud data are projected to the grid, the point cloud projected to the grid is processed comprehensively, and the result obtained from the comprehensive processing is assigned as a pixel value of a pixel in the base map of the road, so as to obtain the base map of the road.

Specifically, the reflectivity of the point cloud in the spliced point cloud data may be projected to the set plane to obtain a reflectivity base map; and the height of the point cloud in the spliced point cloud data may also be projected to the set plane to obtain a height base map. In addition, after the preprocessed point cloud data of each frame is acquired, the preprocessed point cloud data of each frame is projected onto the acquired image of the road according to an external reference of the device that acquires the point cloud data of the road (that is, the acquisition device mentioned above) to the device that acquires an image of the road, and a color corresponding to the preprocessed point cloud data of each frame is obtained. When the color corresponding to the preprocessed point cloud data of each frame is obtained, in the subsequent transformation and splicing of the point cloud data, the color of the point cloud data of each frame is processed synchronously, so there is color information for the spliced point cloud data. Therefore, the color corresponding to the point cloud in the spliced point cloud data may also be projected onto the setting plane to obtain a color base map.

The pixel value of any pixel in the reflectivity base map is the average reflectivity of the point cloud projected to the grid corresponding to that pixel. The pixel value of any pixel in the height base map is the average height of the point cloud projected to the grid corresponding to that pixel. The pixel value of any pixel in the color base map is the average color of the point cloud projected to the grid corresponding to that pixel.

It is to be noted that the spliced point cloud data may be projected once to obtain the above reflectivity base map, height base map, and color base map synchronously. That is, the reflectivity, height, and color of the point cloud in the spliced point cloud data are projected to the set plane at the same time to obtain the reflectivity base map, the height base map, and the color base map synchronously. The spliced point cloud data may also be projected for multiple times. That is, the reflectivity, height, and color of the point cloud in the spliced point cloud data are projected respectively to obtain the reflectivity base map, the height base map, and the color base map. The application does not limit the manner of projecting the point cloud data.

Therefore, the base map of the road includes the reflectivity base map, and further may also include the height base map and/or the color base map.

At S102, pixel set composed of the pixels in the base map that road markings include is determined according to the base map.

If the base map of the road includes the reflectivity base map, the pixel set composed of the pixels that road markings include is determined according to the reflectivity of each pixel on the reflectivity base map;

if the base map of the road includes the color base map, the pixel set composed of the pixels that road markings include is determined according to the color of each pixel on the color base map;

if the base map of the road includes the reflectivity base map and the height base map, the reflectivity base map and the height base map may be input into two branches of a neural network as input data, and output features of the two branches may be calculated respectively; then, the output features of the two branches are fused, and a pixel set composed of the pixels that road markings include is determined according to the fused features. Because the height and reflectivity of the pixel are fused, the recognition accuracy of the road marking is improved;

if the base map of the road includes the color base map and the reflectivity base map, the color base map and the reflectivity base map may be input into two branches of a neural network as input data, and output features of the two branches may be calculated respectively; then, the output features of the two branches are fused, and a pixel set composed of the pixels that road markings include is determined according to the fused features. Because the color and reflectivity of the pixel are fused, the recognition accuracy of the road marking is improved; and

if the base map of the road includes the reflectivity base map, the color base map, and the height base map, the reflectivity base map, the color base map, and the height base map may be input into three branches of the neural network as input data, and the output features of the three branches may be calculated respectively; then, the output features of the three branches are fused, and a pixel set composed of the pixels that road markings include is determined according to the fused features. Because the height, the color, and the reflectivity of the pixel are fused, the recognition accuracy of the road marking is improved.

At S103, at least one road marking is determined according to the determined pixel set.

The road marking is fitted based on the pixel set of each road marking.

It can be seen that in the embodiments of the application, the pixels that road markings include are recognized through the base map of the road to obtain a set of the pixels that road markings include; and the road marking in the base map of the road is fitted according to the set of the pixels of the road marking, and a complete road marking on the base map of the road is fitted at one time; therefore, it is not affected by the size of the base map of the road, and it is not necessary to manually mark or set multiple thresholds to recognize each road marking of the road in the point cloud data.

The process of recognizing the road markings provided in the embodiments of the application is described in detail below.

First, before the pixel set composed of the pixels in the base map that road markings include is determined, the topological line of the road is determined according to a moving track of the device that acquires the point cloud data of the road.

Then, the base map of the road is segmented into multiple block base maps according to the topological line of the road, each of the block base maps is rotated, and the pixel set composed of the pixels in the rotated block base map that road markings include is determined according to each rotated block base map.

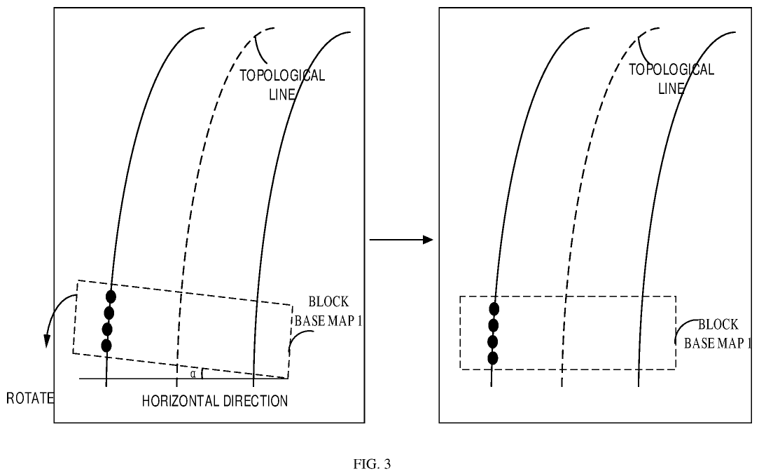

Specifically, as shown in FIG. 2, after the topological line is determined, the base map of the road is equidistantly segmented into the image blocks along the topological line of the road, and multiple block base maps are obtained. Two adjacent block base maps in the base map of the road have an overlapping part, the segmentation line of segmenting the base map of the road is perpendicular to the topological line of the road, and the parts, at two sides of the topological line of the road, of each block base map have the equal width. Because the base map of the road is segmented into blocks, no matter how big the base map of the road is, the implementation scheme of the application may directly fit the road marking on the base map of the road. In addition, because the device that acquires the point cloud data of the road generally moves along the center of the road, that is, the moving track is parallel to the lane line, the lane line in the segmented block base map is parallel to the topological line. Therefore, when the pixel belonging to the lane line in the block base map is recognized, it can be known in advance that the pixel to be recognized is parallel to the topological line, which is equivalent to adding prior information during the recognition, thus improving the recognition accuracy of the lane line.

After that, the pixel set composed of the pixels in each un-rotated block base map (that is, each block base map obtained by segmenting the road base map) that road markings include is determined according to each block base map.

Specifically, as shown in FIG. 3, the included angle α between the segmentation line of each block base map and the horizontal direction is obtained, a transformation matrix corresponding to each block base map is determined according to the included angle α, and the transformation matrix is used to rotate each block base map until its segmentation line is consistent with the horizontal direction, that is, a rotation matrix is used to transform the coordinates of each pixel in each block base map, so that the segmentation line of the block base map is rotated to be consistent with the horizontal direction, that is, the road marking in each block base map is rotated to be parallel to the Y axis of image coordinates. Because the road marking in each block base map is parallel to the Y axis, it is equivalent to adding the prior information during the recognition of the road marking, which simplifies the learning process and improves the recognition accuracy of the road marking.

Further, an initial pixel set composed of the pixels in the rotated block base map that road markings include is determined according to each rotated block base map. The initial pixel set is the pixel set composed of the pixels, belonging to the road marking, in the rotated block base map, so, in order to determine the pixel set composed of the pixels that road markings include in each un-rotated block base map, it is necessary to use the inverse matrix corresponding to the transformation matrix of each un-rotated block base map to transform the pixels in each rotated to block base map that road markings include, thereby determining the real position of each pixel in the initial set in the un-rotated block base map, and obtaining the pixel set composed of the pixels in each un-rotated block base map that the road mark includes.

In addition, the same pixels in the pixel sets composed of the pixels in the adjacent block base maps are merged to obtain the merged pixel set. That is, according to the manner of segmenting the base map of the road, the pixel sets in the adjacent block base maps are merged. It is to be noted that when a certain pixel has probability in two adjacent block base maps, that is, the pixel is in the overlapping part of the adjacent block base maps, when the two adjacent block base maps are merged, the average probability of the pixel in the two adjacent block base maps is assigned as the probability of the pixel in the merged pixel set; and then, at least one road marking is determined according to the merged pixel set.

Optionally, before the merged pixel set is obtained, the probability that each pixel in each block base map belongs to the road marking is determined according to a feature map of each block base map; according to the feature map of each block base map, a n-dimensional feature vector of each pixel whose probability is greater than a preset probability value in each block base map is determined, the n-dimensional feature vector of each pixel including an instance feature (a label of the road marking) of the road marking corresponding to the pixel; according to the n-dimensional feature vector of each pixel whose probability is greater than the preset probability value in the feature map of each block base map, each pixel whose probability is greater than the preset probability value is clustered to obtain the pixel sets corresponding to different road markings in each block base map; then, when the pixel sets corresponding to the same road marking in the adjacent block base maps have the same pixels, the pixel sets corresponding to the same road marking in the adjacent block base maps are merged to obtain the pixel sets corresponding to the different road markings in the base map of the road. That is, the pixel sets of the same road marking are merged according to the label of each road marking in the two adjacent two block base maps to obtain the pixel set of each road marking in the base map of the road; and then, each road marking in the base map of the road is fitted based on the pixel set of each road marking in the base map.

Taking the pixel set corresponding to a road marking in the base map of the road as an example, the process of fitting the road marking is illustrated below.

First, a key point that corresponds to the pixel set corresponding to the road marking is determined according to the pixel set corresponding to the road marking, and then, the road marking is fitted according to the determined key point.

Specifically, because the pixel set of the road marking in the base map of the road is obtained by merging the pixel sets composed of the pixels, belonging to the road marking, in multiple block base maps, if a certain block base map does not include the pixel set of the road marking, it can be seen from the base map of the whole road that the merged pixel set of the road marking is not a continuous pixel set, that is, there may be one or more pixel sets of the road marking. Or, if the pixel on a certain road marking is not recognized from the overlapping part of two adjacent block base maps, then the pixel sets composed of the pixels, belonging to the road marking, in the two adjacent block base maps cannot be merged, so there are at least two pixel sets of the road marking.

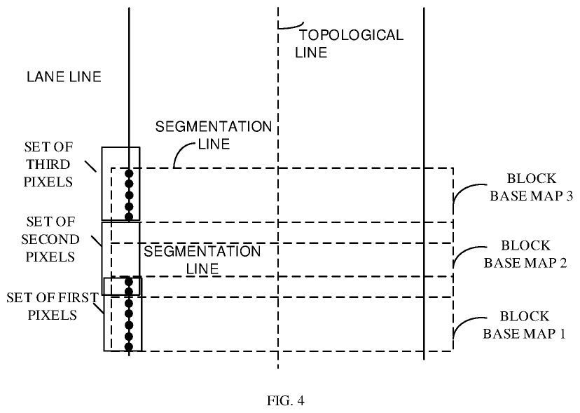

As shown in FIG. 4, due to an acquisition error, the absence or ambiguity of the lane line, or the poor recognition accuracy, only the set composed of a part of pixels corresponding to the lane line is recognized in the block base map 2 and the block base map 3. For example, the pixel set belonging to the lane line in the block base map 1 is the set of first pixels, the pixel set belonging to the lane line in the block base map 2 is the set of second pixels, and the pixel set belonging to the lane line in the block base map 3 is the set of third pixels. When the pixel sets corresponding to the same lane line in the adjacent block base maps are merged, because the set of first pixels and the set of second pixels have the same pixels, the set of first pixels and the set of second pixels may be merged to obtain the merged set. Because the set of third pixels and the set of second pixels do not have the same pixels, the set of second pixels and the set of third pixels cannot be merged. Therefore, after the sets are merged, two pixel sets corresponding to the lane line are obtained, that is, the set obtained by merging the set of the first pixels and the set of the second pixels, and the set of the third pixels.

In this way, when there is one pixel set corresponding to the road marking (assuming that it is the first set), a main direction of the first set is determined, the rotation matrix corresponding to the first set is determined according to the main direction, and the pixel in the first set is transformed according to the determined rotating matrix, so as to make the main direction of the transformed first set as the horizontal direction, that is, make the main direction of the first set as close as possible to the direction of the road marking. Then, multiple key points are determined according to the first set whose main direction is transformed. Because the determined key point is the rotated pixel, the key point is not the real pixel in the first set, so it is necessary to use the inverse matrix of the transformation matrix to transform each key point, so that the key point obtained after rotation is transformed into the pixel in the first set; and then, a line segment corresponding to the first set is fitted by using the transformed key point, and the road marking may be obtained according to the line segment corresponding to the first set.

Specifically, the first set whose main direction is transformed is assigned as the set to be processed, and the leftmost pixel (the pixel with the minimum abscissa) and the rightmost pixel (the pixel with the maximum abscissa) in the set to be processed are determined. It is to be noted that when there are multiple leftmost pixels, the average of ordinates of the multiple leftmost pixels is obtained, and pixel corresponding to the average of ordinates and the minimum abscissa is assigned as the leftmost pixel. Similarly, when there are multiple rightmost pixels, the average of ordinates of the multiple rightmost pixels is obtained, and pixel corresponding to the average of ordinates and the maximum abscissa is assigned as the rightmost pixel.

As shown in FIG. 5, if the interval length of the set to be processed is less than or equal to the first threshold, and the average distance is less than the second threshold, a key point A is determined based on the leftmost pixel, and a key point B is determined based on the rightmost pixel; then, the road marking (the line segment AB) corresponding to the set to be processed is fitted based on the key point A and the key point B. The interval length is the difference between the abscissas of the rightmost pixel B and the leftmost pixel A, and the average distance is the average of distances between the pixels in the set to be processed and the line segment AB formed by the leftmost pixel A and the rightmost pixel B.

Further, if the interval length of the set to be processed is less than or equal to the first threshold, and the average distance is greater than the second threshold, the set to be processed is discarded.

As shown in FIG. 5, if the interval length of the set to be processed is greater than the first threshold, a segmentation coordinate C corresponding to the set to be processed is first determined, the segmentation coordinate C being the average of the abscissas of the pixels in the set to be processed, and the set composed of the pixels, whose abscissa is less than or equal to the segmentation coordinate, in the set to be processed is assigned as the first subset, and set composed of the pixels, whose abscissa is greater than or equal to the segmentation coordinate, in the set to be processed is assigned as the second subset.

After that, the first subset and the second subset are assigned as the set to be processed respectively to perform the above steps for processing in terms of the interval length and the average distance. That is, if the interval length of the first subset (or the second subset) is greater than the first threshold, the first subset (or the second subset) is further split to obtain multiple subsets until the interval length of the subset is less than the first threshold. When the interval length is less than the first threshold, it is determine whether the average of distances between the pixels in each subset and the line segment formed by the leftmost pixel and the rightmost pixel in the subset is less than the second threshold; if so, the leftmost pixel and rightmost pixel in the subset are assigned as two key points, and the road marking corresponding to the subset is fitted based on the two key points; if not, the subset is discarded, the road marking is not fitted for the subset, and the road marking is fitted according to other subsets that are not discarded.

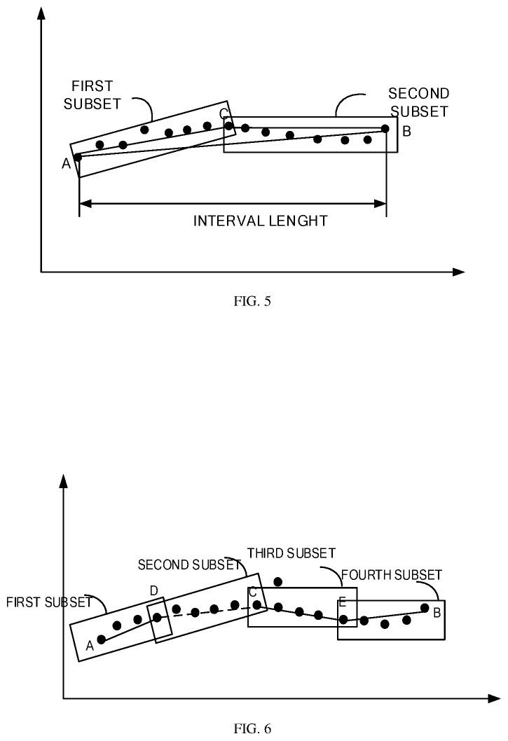

For example, as shown in FIG. 6, the first set is split into the first subset, the second subset, the third subset, and the fourth subset. If the interval length of the second subset is less than the first threshold and the average of distance between the pixels in the second subset and the line segment DC is greater than the second threshold, the second subset is discarded. Therefore, the key point is not determined in the second subset, but the key points A, D, C, E, and B may be connected sequentially to obtain the line segment corresponding to the first set.

Further, based on the above manner of fitting the road marking, if the first set is segmented, multiple line segments corresponding to each first set may be obtained.

If there are multiple pixel sets corresponding to a road marking, one of the pixel sets corresponding to the road marking is assigned as the first set. The line segments corresponding to the first set that are fitted according to the above method are not connected. When the distance between the two endpoints with the smallest distance in the two line segments that are not connected is less than a distance threshold, and the endpoints of the two line segments that are not connected are collinear, the two line segments that are not connected are connected to obtain the spliced line segment. The spliced line segment is assigned as the road marking.

After the line segment corresponding to each road marking is determined from the base map of the road, the base map of the road and determined line segment may be stored in a specific format, such as a GeoJson file format, so that they may be input into the existing map editing tool for adjustment to generate a complete road marking.

The pixel set composed of the pixels in the base map that road markings include is determined according to the base map of the road is performed by the neural network. The neural network is trained with a sample base map marked with the road marking. The sample base map is obtained by marking the base map of the road with a marking tool. The sample base map includes lane lines, sidewalks, and stop lines.

Specifically, the line segment is drawn on a black image according to a gray value 250 (the coordinate is consistent with the base map) as the lane line in the base map. The line segment is drawn on the black image according to a gray value 251 as the stop line. A matrix is drawn on the black image according to a gray value 252 as the sidewalk. After that, an instance label is added to each lane line and different labels (0-255) are given to different lane lines, that is, a label is added to each lane line to distinguish different lane lines, and the label of each lane line is drawn on the black image, then the black image is the sample block base map marked with the road marking.

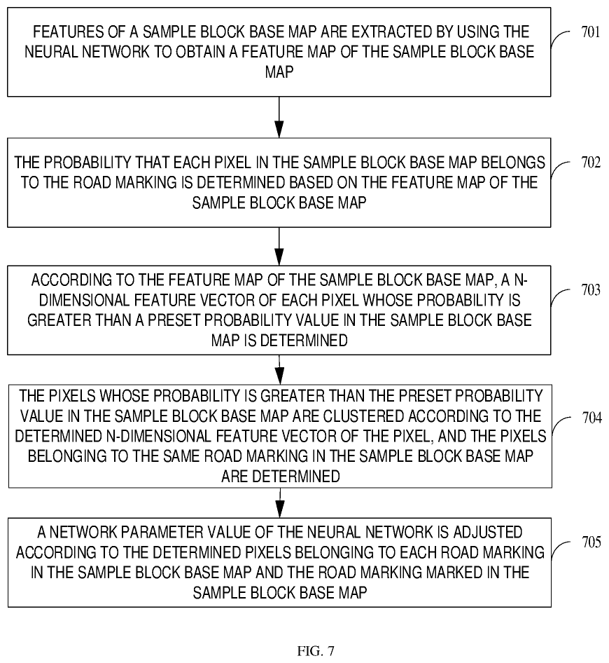

With reference to FIG. 7 which is a flowchart of a neural network training method provided by an embodiment of the application, the method includes the following steps.

At S701, features of a sample block base map are extracted by using the neural network to obtain a feature map of the sample block base map.

At S702, the probability that each pixel in the sample block base map belongs to the road marking is determined based on the feature map of the sample block base map.

That is, the pixels in the sample block base map are classified according to the feature map of the sample block base map, so as to determine the probability that each pixel in the sample block base map belongs to the road marking.

At S703, according to the feature map of the sample block base map, a n-dimensional feature vector of each pixel whose probability is greater than a preset probability value in the sample block base map is determined.

Each pixel whose probability is greater than the preset probability value is assigned as the pixel belonging to the road marking. The n-dimensional feature vector of the pixel is used to represent the instance feature of the road marking of the pixel, that is, which road marking the pixel belongs to.

At S704, the pixels whose probability is greater than the preset probability value in the sample block base map are clustered according to the determined n-dimensional feature vector of the pixel, and the pixels belonging to the same road marking in the sample block base map are determined.

That is, the pixels belonging to the road marking in the sample base map are clustered according to the instance feature of the road marking of each pixel, so as to obtain multiple clustering results. Each clustering result corresponds to a clustering center, and all pixels corresponding to each clustering result correspond to a road marking.

At S705, a network parameter value of the neural network is adjusted according to the determined pixels belonging to each road marking in the sample block base map and the road marking marked in the sample block base map.

That is, a first loss is determined according to the pixels belonging to each road marking in the sample block base map and the road marking marked in the sample block base map, and the network parameter value of the neural network is adjusted based on the first loss.

The first loss may be expressed by the formula (1):

Loss₁=α·LOSSᵥₐᵣ+β·Loss_{dist}+γ·LOSS_{reg} (1),

where Loss₁ is the first loss, and α, β, γ are preset weight coefficients,

$${Loss}_{var} = \frac{1}{C} {\sum }_{j = 1}^{C} \frac{1}{Nc} {\sum }_{i = 1}^{Nc} {[ ‖ {μ}_{j} - {x}_{i} ‖ - {δ}_{v} ]}_{+}^{2} , \\ {Loss}_{dist} = \frac{1}{C ( C - 1 )} {\sum }_{CA = 1}^{C} {\sum }_{CB = 1 \\ CA \neq CB}^{C} {[ 2 {δ}_{d} - ‖ {μ}_{CA} - {μ}_{CB} ‖ ]}_{+}^{2} , and$$

$${L}_{reg} = \frac{1}{C} {\sum }_{j = 1}^{C} ‖ {μ}_{j} ‖ ,$$

where C is the number of clustering results, N_{c} is the number of pixels in each clustering result, μⱼ is the clustering center of the j-th clustering result, [x], =max(0,x), δᵥ and δ_{d} are preset variance and boundary value.

In a possible implementation mode, after the sample block base map is obtained, a marked distance of the first pixel in the sample block base map is determined, the first pixel being any pixel in the sample block base map, the marked distance of the first pixel being the distance between the first pixel and the second pixel, the second pixel being the pixel with the minimum distance from the first pixel in the pixels that are in the road marking marked in the sample block base map; then, the network parameter value of the neural network is adjusted according to the determined pixels belonging to each road marking in the sample block base map, the marked distance of the first pixel in the sample block base map and a predicted distance of the first pixel in the sample block base map. The predicted distance of the first pixel is the distance between the first pixel and a third pixel, and the third pixel is the pixel with the minimum distance from the first pixel in the determined pixels belonging to each road marking in the sample block base map.

Specifically, the first loss is determined according to the determined pixels belonging to each road marking in the sample block base map and the pixel corresponding to the road marking marked in the sample block base map; next, a second loss is determined based on the marked distance of the first pixel in the sample block base map and the predicted distance of the first pixel in the sample block base map; then, the network parameter value of the neural network is comprehensively adjusted based on the first loss and the second loss. Because two losses are combined to adjust the network parameter of the neural network, the recognition accuracy of the neural network is improved.

The second loss may be expressed by the formula (2):

$$Los {s}_{2} = \sqrt{{\sum }_{i = 1}^{N} {( {d}_{i} - {d}_{i}^{′} )}^{2}} , \qquad ( 2 )$$

where Loss₂ is the second loss, dᵢ is the marked distance of the i-th pixel in the sample block base map, dᵢ′ is the predicted distance of the i-th pixel, and N is the total number of pixels in the sample block base map.

In a possible implementation mode, the training method may further include:

a marked direction of a fourth pixel in the block base map is determined, the fourth pixel being any pixel in the sample block base map, the marked direction of the fourth pixel is a tangent direction of a fifth pixel, and the fifth pixel being the pixel with the minimum distance from the fourth pixel in the pixels on the road marking marked in the sample block base map; and then, the network parameter value of the neural network is adjusted according to the determined pixels belonging to each road marking in the sample block base map, the road marking marked in the sample block base map, the marked direction of the fourth pixel in the sample block base map and the predicted direction of the fourth pixel in the sample block base map. The predicted direction of the fourth pixel is the tangent direction of the sixth pixel, and the sixth pixel is the pixel with the minimum distance from the fourth pixel in the determined pixels belonging to each road marking in the sample block base map.

Specifically, a third loss is determined based on the marked direction of the fourth pixel and the predicted direction of the fourth pixel in the sample block base map, and then the network parameter value of the neural network may be adjusted in combination with the first loss and the third loss or in combination with the first loss, the second loss, and the third loss. The third loss may be expressed by the formula (3):

$$Los {s}_{3} = \sqrt{{\sum }_{i = 1}^{N} {( {tan}_{i} - {tan}_{i}^{′} )}^{2}} , \qquad ( 3 )$$

where Loss₃ is the third loss, tanᵢ is a slope corresponding to the marked distance of the i-th pixel in the sample block base map, tanᵢ′ is a slope of the predicted distance of the i-th pixel, and N is the total number of pixels in the sample block base map.

Of course, in practical application, the marked direction and predicted direction of the fourth pixel may also be represented by a tangent vector. Then, a mean variance of the difference between the marked direction and the predicted direction of each pixel in the sample block base map is determined by calculating the distance between the vectors, and the mean variance is assigned as the third loss.

In a possible implementation mode, the sample block base map is obtained by segmenting the sample base map in the same way as segmenting the base map of the road. In addition, before the sample base map is segmented, the position and direction of the topological line may also be disturbed, so as to increase the diversity of the sample block base map to improve the recognition accuracy of the neural network.

In a possible implementation mode, when the neural network is trained, a small number of sample block base maps marked with road marking may be used to train the neural network. Then, the trained neural network is used to recognize the road marking of the block base map where the road marking is not marked, the unmarked road marking is marked according to the recognized road marking, and a training sample is reconstructed by the block base map whose road marking is recognized and the sample block base map where the road marking is marked to train the neural network. Because only a small number of sample block base maps with marked road markings are needed, the complexity of the marking process is reduced and the user experience is improved.

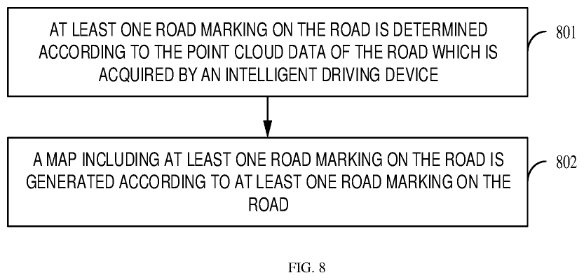

With reference to FIG. 8 which is a flowchart of a map generation method provided by an embodiment of the application, the method is applied to an intelligent driving device. The method of the present embodiment includes the following steps.

At S801, at least one road marking on the road is determined according to the point cloud data of the road which is acquired by an intelligent driving device.

The intelligent driving device includes an autonomous vehicle, a vehicle equipped with Advanced Driving Assistant System (ADAS), an intelligent robot, and so on.

The above road marking recognition method may be referred to in the implementation process that the intelligent driving device determines at least one road marking on the road according to the acquired point cloud data of the road, which will not be described here.

At S802, a map including at least one road marking on the road is generated according to at least one road marking on the road.

That is, according to the recognition of at least one road marking on the road, the at least one road marking is marked on the generated map of the road to obtain the map including at least one road marking on the road.

It can be seen that in the embodiments of the application, when driving on the road, the intelligent driving device may use the acquired point cloud data to automatically establish a high-precision map of the road (that is, each road marking on the road is marked), so as to improve the driving safety of the intelligent device when driving on the road based on the high-precision map.

Further, after the map is obtained, the map may be corrected to obtain a corrected map.

In a possible implementation mode, the at least one road marking is determined by the neural network, so after the map is generated or the corrected map is obtained, the generated map or the corrected map may be used to train the neural network, that is, the map marked with the road marking is assigned as a new training sample to train the neural network model. Because the neural network model is continuously trained with the new training sample, the recognition accuracy of the neural network can be gradually improved, so as to improve the accuracy of recognizing the road marking of the road and make the constructed map more accurate.

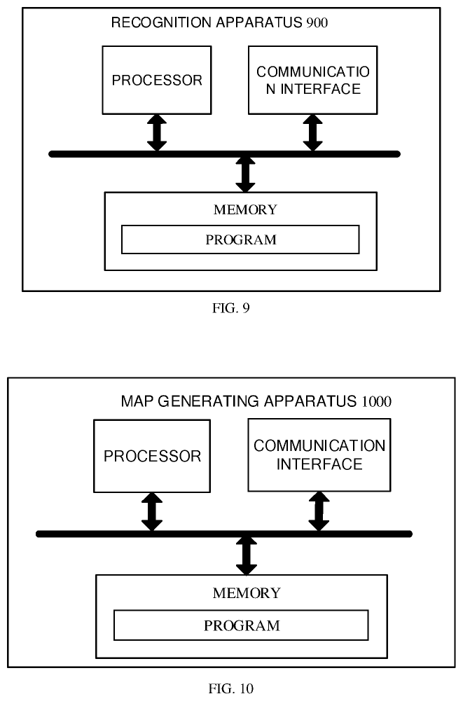

FIG. 9 is a structural schematic diagram of a road marking recognition apparatus provided by an embodiment of the application. The road marking recognition apparatus 900 may include a processor, a memory, a communication interface, and one or more programs. The one or more programs are stored in the memory and configured to be executed by the processor. The program includes an instruction for performing the following steps:

the base map of the road is determined according to the acquired point cloud data of the road, the pixels in the base map being determined according to the reflectivity information of the acquired point cloud and the position information of the point cloud;

the pixel set composed of the pixels in the base map that road markings include is determined according to the base map; and

at least one road marking is determined according to the determined pixel set.

In a possible implementation mode, before the pixel set composed of the pixels in the base map that road markings include is determined according to the base map, the above program is also used to execute an instruction of the following step:

the base map of the road is segmented into multiple block base maps according to the topological line of the road;

in terms of determining the pixel set composed of the pixels in the base map that road markings include according to the base map, the above program is specifically used to execute an instruction of the following step:

the pixel set composed of the pixels in each block base map that road markings include is determined according to the block base map.

In a possible implementation mode, in terms of determining the pixel set composed of the pixels in each block base map that road markings include according to the block base map, the above program is specifically used to execute an instruction of the following steps:

each block base map is rotated respectively; and

the pixel set composed of the pixels in each un-rotated block base map that road markings include is determined according to each rotated block base map.

In a possible implementation mode, in terms of segmenting the base map of the road into multiple block base maps according to the topological line of the road, the above program is specifically used to execute an instruction of the following steps:

the topological line of the road is determined according to the moving track of the device that acquires the point cloud data of the road; and

the base map of the road is equidistantly segmented into the image blocks along the topological line of the road, and multiple block base maps are obtained. Two adjacent block base maps in the base map of the road have an overlapping part, the segmentation line of segmenting the base map of the road is perpendicular to the topological line of the road, and the parts, at two sides of the topological line of the road, of each block base map have the equal width.

In a possible implementation mode, in terms of determining at least one road marking according to the determined pixel set, the above program is specifically used to execute an instruction of the following steps:

the pixel sets composed of the pixels in the adjacent block base maps with the same pixels are merged to obtain the merged pixel set. When the same pixel has multiple probabilities in the merged pixel set, the average of multiple probabilities of the same pixel is assigned as the probability of the pixel; and

at least one road marking is determined according to the merged pixel set.

In a possible implementation mode, in terms of rotating each block base map respectively, the above program is specifically used to execute an instruction of the following steps:

the transformation matrix corresponding to each block base map is determined according to the included angle between the segmentation line of each block base map and the horizontal direction;

according to the transformation matrix corresponding to each block base map, each block base map is rotated until its segmentation line is consistent with the horizontal direction. The segmentation line of a block base map is a straight line along which the block base map is segmented from the base map of the road;

in terms of determining the pixel set composed of the pixels in each un-rotated block base map that road markings include according to each rotated block base map, the above program is specifically used to execute an instruction of the following to steps:

the initial pixel set composed of the pixels in the rotated block base map that road markings include is determined according to each rotated block base map; and

according to the inverse matrix of the transformation matrix corresponding to each un-rotated block base map, the pixels in each rotated block base map that road markings include are transformed to obtain the pixel set composed of the pixels in each un-rotated block base map that road markings include.

In a possible implementation mode, in terms of determining the pixel set composed of the pixels in each block base map that road markings include according to the block base map, the above program is specifically used to execute an instruction of the following steps:

the probability that each pixel in each block base map belongs to the road marking is determined according to the feature map of each block base map;

according to the feature map of each block base map, the n-dimensional feature vector of each pixel whose probability is greater than the preset probability value in each block base map is determined;

according to the n-dimensional feature vector of each pixel whose probability is greater than the preset probability value in the feature map of each block base map, each pixel whose probability is greater than the preset probability value is clustered to obtain the pixel sets corresponding to different road markings in each block base map;

in terms of merging the pixel sets composed of the pixels in the adjacent block base maps with the same pixels to obtain the merged pixel set, the above program is specifically used to execute an instruction of the following step:

when the pixel sets corresponding to the same road marking in the adjacent block base maps have the same pixels, the pixel sets corresponding to the same road marking in the adjacent block base maps are merged to obtain the pixel sets corresponding to the different road markings in the base map of the road;

in terms of determining at least one road marking according to the merged pixel set, the above program is specifically used to execute an instruction of the following step:

each road marking is determined according to the pixel set corresponding to each road marking.

In a possible implementation mode, in terms of determining each road marking to according to the pixel set corresponding to each road marking, the above program is specifically used to execute an instruction of the following steps:

for a road marking, the key point that corresponds to the pixel set corresponding to the road marking is determined according to the pixel set corresponding to the road marking;

the road marking is fitted based on the determined key point.

In a possible implementation mode, in terms of determining the key point that corresponds to the pixel set corresponding to the road marking according to the pixel set corresponding to the road marking, the above program is specifically used to execute an instruction of the following steps:

the main direction of the first set is determined by taking the pixel set corresponding to the road marking as the first set;

the rotation matrix is determined according to the determined main direction of the first set;

according to the determined rotation matrix, the pixels in the first set are transformed, so that the main direction of the first set after the pixel is transformed is the horizontal direction;

multiple key points are determined according to the first set whose main direction is transformed;

in terms of fitting the road marking based on the determined key point, the above program is specifically used to execute an instruction of the following steps:

the determined multiple key points are transformed based on the inverse matrix of the rotation matrix;

the line segment corresponding to the first set is fitted based on the transformed multiple key points; and

the line segment corresponding to the first set is assigned as the road marking.

In a possible implementation mode, when there are multiple pixel sets corresponding to a road marking, one of the pixel sets corresponding to the road marking is assigned as the first set, and the fitted line segments corresponding the first sets are not connected, the above program is specifically used to execute an instruction of the following steps:

if there are unconnected line segments in the line segments corresponding to the first sets, when the distance between two endpoints with the smallest distance in unconnected two line segments is less than a distance threshold, and the endpoints of the unconnected two line segments are collinear, the unconnected two line segments are connected to obtain the spliced line segment; and

the spliced line segment is assigned as the road marking.

In a possible implementation mode, in terms of determining multiple key points according to the first set whose main direction is transformed, the above program is specifically used to execute an instruction of the following steps:

the first set whose main direction is transformed is assigned as the set to be processed.

the leftmost pixel and the rightmost pixel in the set to be processed are determined;

when the interval length is less than or equal to the first threshold and the average distance is less than the second threshold, a key point is determined based on the leftmost pixel, and a key point is determined based on the rightmost pixel, the average distance being the average of the distances between the pixels in the set to be processed and the line segment formed by the leftmost pixel and the rightmost pixel, and the interval length being the difference between the abscissa of the rightmost pixel and the abscissa of the leftmost pixel in the set to be processed; and

when the interval length is less than or equal to the first threshold, and the average distance is greater than the second threshold, the pixels in the set to be processed are discarded.

In a possible implementation mode, the above program is specifically used to execute an instruction of the following steps:

when the interval length is greater than the first threshold, the average of the abscissas of the pixels in the set to be processed is assigned as the segment coordinate, the set composed of the pixels, whose abscissas are less than or equal to the segment coordinate, in the set to be processed is assigned as the first subset, the set composed of the pixels, whose abscissas are greater than or equal to the segment coordinate, in the set to be processed is assigned as the second subset, and taking the first subset and the second subset respectively as the set to be processed, the step of processing the set to be processed is performed.

In a possible implementation mode, in terms of determining the base map of the road according to the acquired point cloud data of the road, the above program is specifically used to execute an instruction of the following steps:

a non-road point cloud is recognized and removed from the acquired point cloud data of the road, and preprocessed point cloud data is obtained;

according to an attitude of the device that acquires the point cloud data of the road, the preprocessed point cloud data of each frame is transformed into the world coordinate system, and the transformed point cloud data of each frame is obtained;

the transformed point cloud data of each frame is spliced to obtain the spliced point cloud data;

the spliced point cloud data is projected to the set plane, the set plane being provided with grids divided according to a fixed length-width resolution, and each grid corresponding to a pixel in the base map of the road;

for a grid in the set plane, the pixel value of the pixel in the base map of the road corresponding to the grid is determined according to the average reflectivity of the point cloud projected to the grid.

In a possible implementation mode, in terms of for a grid in the set plane, determining the pixel value of the pixel in the base map of the road corresponding to the grid according to the average reflectivity of the point cloud projected to the grid, the above program is specifically used to execute an instruction of the following step:

for a grid in the set plane, the pixel value of the pixel in the base map of the road corresponding to the grid is determined according to the average reflectivity and the average height of the point cloud projected to the grid.

In a possible implementation mode, after the preprocessed point cloud data is obtained, the above program is specifically used to execute an instruction of the following step:

according to the external reference of the device that acquires the point cloud data of the road to the device that acquires the image of the road, the preprocessed point cloud data is projected onto the acquired image of the road, and colors corresponding to the preprocessed point cloud data are obtained;

in terms of for a grid in the set plane, determining the pixel value of the pixel in the base map of the road corresponding to the grid according to the average reflectivity of the point cloud projected to the grid, the above program is specifically used to execute an instruction of the following step:

for a grid in the set plane, the pixel value of the pixel in the base map of the road corresponding to the grid is determined according to the average reflectivity of the point cloud projected to the grid and the average color corresponding to the point cloud projected to the grid.

In a possible implementation mode, that the pixel set composed of the pixels in the base map that road markings include is determined according to the base map is performed by the neural network. The neural network is trained with the sample base map marked with the road marking.

In a possible implementation mode, in terms of training the neural network, the above program is specifically used to execute an instruction of the following steps:

the neural network is used to extract features of the sample block base map to obtain the feature map of the sample block base map;

the probability that each pixel in the sample block base map belongs to the road marking is determined based on the feature map of the sample block base map;

the n-dimensional feature vector of each pixel whose probability is greater than the preset probability value in the sample block base map is determined according to the feature map of the sample block base map. The n-dimensional feature vector is used to represent an instance feature of the road marking, and n is an integer greater than 1;
the pixels whose probability is greater than the preset probability value in the sample block base map are clustered according to the determined n-dimensional feature vector of the pixel, and the pixels belonging to the same road marking in the sample block base map are determined; and

a network parameter value of the neural network is adjusted according to the determined pixels belonging to each road marking in the sample block base map and the road marking marked in the sample block base map.

In a possible implementation mode, the above program is specifically used to execute an instruction of the following step:

the marked distance of the first pixel in the sample block base map is determined, the first pixel being any pixel in the sample block base map, the marked distance of the first pixel being the distance between the first pixel and the second pixel, the second pixel being the pixel with the minimum distance from the first pixel in the pixels that are in the road marking marked in the sample block base map;

in terms of adjusting the network parameter value of the neural network according to the determined pixels belonging to each road marking in the sample block base map and the road marking marked in the sample block base map, the above program is specifically used to execute an instruction of the following step:

the network parameter value of the neural network is adjusted according to the determined pixels belonging to each road marking in the sample block base map, the road marking marked in the sample block base map, the marked distance of the first pixel in the sample block base map and the predicted distance of the first pixel in the sample block base map; and

the predicted distance of the first pixel is the distance between the first pixel and the third pixel, and the third pixel is the pixel with the minimum distance from the first pixel in the determined pixels belonging to each road marking in the sample block base map.

In a possible implementation mode, the above program is specifically used to execute an instruction of the following step:

the marked direction of the fourth pixel in the sample block base map is determined, the fourth pixel being any pixel in the sample block base map, the marked direction of the fourth pixel being the tangent direction of the fifth pixel, the fifth pixel being the pixel with the minimum distance from the fourth pixel in the pixels that are in the road marking marked in the sample block base map; and

in terms of adjusting the network parameter value of the neural network according to the determined pixels belonging to each road marking in the sample block base map and the road marking marked in the sample block base map, the above program is specifically used to execute an instruction of the following step:

the network parameter value of the neural network is adjusted according to the determined pixels belonging to each road marking in the sample block base map, the road marking marked in the sample block base map, the marked direction of the fourth pixel in the sample block base map and a predicted direction of the fourth pixel in the sample block base map; and

the predicted direction of the fourth pixel is the tangent direction of the sixth pixel, and the sixth pixel is the pixel with the minimum distance from the fourth pixel in the determined pixels belonging to each road marking in the sample block base map.

FIG. 10 is a structural schematic diagram of a map generation apparatus provided by an embodiment of the application. The map generating apparatus 1000 may include a processor, a memory, a communication interface and one or more programs. The one or more programs are stored in the memory and configured to be executed by the processor. The program includes an instruction for performing the following steps:

at least one road marking on the road is determined according to the point cloud data of the road which is acquired by the intelligent driving device; and

the map including at least one road marking on the road is generated according to at least one road marking on the road.

In a possible implementation mode, the above program is further used to execute an instruction of the following step:

the generated map is corrected, and the corrected map is obtained.

In a possible implementation mode, the at least one road marking is determined by the neural network. After the map is generated, the above program is further used to execute an instruction of the following step:

the neural network is trained by using the generated map.

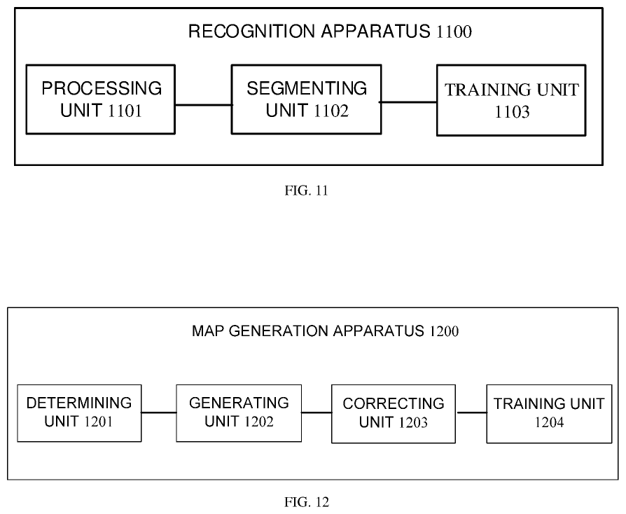

FIG. 11 is a block diagram of function units of a road marking recognition apparatus provided by an embodiment of the application. The recognition apparatus 1100 may include a processing unit 1101.

The processing unit 1101 is configured to determine the base map of the road according to the acquired point cloud data of the road. The pixels in the base map are determined according to the reflectivity information of the acquired point cloud and the position information of the point cloud.

The processing unit 1101 is further configured to determine the pixel set composed of the pixels in the base map that road markings include according to the base map.

The processing unit 1101 is further configured to determine at least one road marking according to the determined pixel set.

In a possible implementation mode, the recognition apparatus 1100 may further include a segmenting unit 1102.

Before the pixel set composed of the pixels in the base map that road markings include is determined according to the base map, the segmenting unit 1102 is configured to segment the base map of the road into multiple block base maps according to the topological line of the road;

in terms of determining the pixel set composed of the pixels in the base map that road markings include according to the base map, the processing unit 1101 is specifically configured to:

determine the pixel set composed of the pixels in the block base map that road markings include according to each block base map.

In a possible implementation mode, in terms of determining the pixel set composed of the pixels in the block base map that road markings include according to each block base map, the processing unit 1101 is specifically configured to:

rotate each block base map respectively; and

determine the pixel set composed of the pixels in each un-rotated block base map that road markings include according to each rotated block base map.

In a possible implementation mode, in terms of segmenting the base map of the road into multiple block base maps according to the topological line of the road, the segmenting unit 1102 is specifically configured to:

determine the topological line of the road according to the moving track of the device that acquires the point cloud data of the road; and

equidistantly segment the base map of the road into the image blocks along the topological line of the road, and obtain multiple block base maps. Two adjacent block base maps in the base map of the road have an overlapping part, the segmentation line of segmenting the base map of the road is perpendicular to the topological line of the road, and the parts, at two sides of the topological line of the road, of each block base map have the equal width.

In a possible implementation mode, in terms of determining at least one road marking according to the determined pixel set, the processing unit 1101 is specifically configured to:

merge the pixel sets composed of the pixels in the adjacent block base maps with the same pixels to obtain a merged pixel set; when the same pixel has multiple probabilities in the merged pixel set, the average of multiple probabilities of the same pixel is assigned as the probability of the pixel; and

determine at least one road marking according to the merged pixel set.

In a possible implementation mode, in terms of rotating each block base map respectively, the processing unit 1101 is specifically configured to:

determine the transformation matrix corresponding to each block base map according to the included angle between the segmentation line of each block base map and the horizontal direction;

according to the transformation matrix corresponding to each block base map, rotate each block base map until its segmentation line is consistent with the horizontal direction. The segmentation line of a block base map is a straight line along which the block base map is segmented from the base map of the road;

In terms of determining the pixel set composed of the pixels in each un-rotated to block base map that road markings include according to each rotated block base map, the processing unit 1101 is specifically configured to:

determine the initial pixel set composed of the pixels in the rotated block base map that road markings include according to each rotated block base map; and

according to the inverse matrix of the transformation matrix corresponding to each un-rotated block base map, transform the pixels in each rotated block base map that road markings include to obtain the pixel set composed of the pixels in each un-rotated block base map that road markings include.

In a possible implementation mode, in terms of determining the pixel set composed of the pixels in the block base map that road markings include according to each block base map, the processing unit 1101 is specifically configured to:

determine the probability that each pixel in each block base map belongs to the road marking according to the feature map of each block base map;

according to the feature map of each block base map, determine the n-dimensional feature vector of each pixel whose probability is greater than the preset probability value in each block base map; and

according to the n-dimensional feature vector of each pixel whose probability is greater than the preset probability value in the feature map of each block base map, cluster each pixel whose probability is greater than the preset probability value to obtain the pixel sets corresponding to different road markings in each block base map;

in terms of merging the pixel sets composed of the pixels in the adjacent block base maps with the same pixels to obtain the merged pixel set, the processing unit 1101 is specifically configured to:

when the pixel sets corresponding to the same road marking in the adjacent block base maps have the same pixels, merge the pixel sets corresponding to the same road marking in the adjacent block base maps to obtain the pixel sets corresponding to the different road markings in the base map of the road;

in terms of determining at least one road marking according to the merged pixel set, the processing unit 1101 is specifically configured to:

determine each road marking according to the pixel set corresponding to each road marking.

In a possible implementation mode, in terms of determining each road marking according to the pixel set corresponding to each road marking, the processing unit 1101 is specifically configured to:

for a road marking, determine the key point that corresponds to the pixel set corresponding to the road marking according to the pixel set corresponding to the road marking; and

fit the road marking based on the determined key point.

In a possible implementation mode, in terms of determining the key point that corresponds to the pixel set corresponding to the road marking according to the pixel set corresponding to the road marking, the processing unit 1101 is specifically configured to:

determine the main direction of the first set by taking the pixel set corresponding to the road marking as the first set;

determine the rotation matrix according to the determined main direction of the first set;

according to the determined rotation matrix, transform the pixels in the first set, so that the main direction of the first set after the pixel is transformed is the horizontal direction; and

determine multiple key points according to the first set whose main direction is transformed;

in terms of fitting the road marking based on the determined key point, the processing unit 1101 is specifically configured to:

transform the determined multiple key points based on the inverse matrix of the rotation matrix;

fit the line segment corresponding to the first set based on the transformed multiple key points; and

take the line segment corresponding to the first set as the road marking.

In a possible implementation mode, when there are multiple pixel sets corresponding to a road marking, one of the pixel sets corresponding to the road marking is assigned as the first set, and the fitted line segments corresponding the first sets are not connected. The processing unit 1101 is further configured to:

if there are unconnected line segments in the line segments corresponding to the first sets, when the distance between two endpoints with the smallest distance in unconnected two line segments is less than a distance threshold, and the endpoints of the unconnected two line segments are collinear, connect the unconnected two line segments to obtain the spliced line segment; and

take the spliced line segment as the road marking.

In a possible implementation mode, in terms of determining multiple key points according to the first set whose main direction is transformed, the processing unit 1101 is specifically configured to:

take the first set whose main direction is transformed as the set to be processed;

determine the leftmost pixel and the rightmost pixel in the set to be processed;

when the interval length is less than or equal to the first threshold and the average distance is less than the second threshold, determine a key point based on the leftmost pixel, and determine a key point based on the rightmost pixel, the average distance being the average of the distances between the pixels in the set to be processed and the line segment formed by the leftmost pixel and the rightmost pixel, and the interval length being the difference between the abscissa of the rightmost pixel and the abscissa of the leftmost pixel in the set to be processed; and

when the interval length is less than or equal to the first threshold, and the average distance is greater than the second threshold, discard the pixels in the set to be processed.

In a possible implementation mode, the processing unit 1101 is further configured to:

when the interval length is greater than the first threshold, take the average of the abscissas of the pixels in the set to be processed as the segment coordinate, take the set composed of the pixels, whose abscissas are less than or equal to the segment coordinate, in the set to be processed as the first subset, take the set composed of the pixels, whose abscissas are greater than or equal to the segment coordinate, in the set to be processed as the second subset, and taking the first subset and the second subset respectively as the set to be processed, perform the step of processing the set to be processed.

In a possible implementation mode, in terms of determining the base map of the road according to the acquired point cloud data of the road, the processing unit 1101 is specifically configured to:

recognize and remove the non-road point cloud from the acquired point cloud data of the road, and obtain the preprocessed point cloud data;

according to the attitude of the device that acquires the point cloud data of the road, transform the preprocessed point cloud data of each frame into the world coordinate system, and obtain the transformed point cloud data of each frame;

splice the transformed point cloud data of each frame to obtain the spliced point cloud data;

project the spliced point cloud data to a set plane, the set plane being provided with grids divided according to the fixed length-width resolution, and each grid corresponding to a pixel in the base map of the road; and

for a grid in the set plane, determine the pixel value of the pixel in the base map of the road corresponding to the grid according to the average reflectivity of the point cloud projected to the grid.

In a possible implementation mode, in terms of for a grid in the set plane, determining the pixel value of the pixel in the base map of the road corresponding to the grid according to the average reflectivity of the point cloud projected to the grid, the processing unit 1101 is specifically configured to:

for a grid in the set plane, determine the pixel value of the pixel in the base map of the road corresponding to the grid according to the average reflectivity and the average height of the point cloud projected to the grid.

In a possible implementation mode, after the preprocessed point cloud data is obtained, the processing unit 1101 is further configured to:

according to the external reference of the device that acquires the point cloud data of the road to the device that acquires the image of the road, project the preprocessed point cloud data onto the acquired image of the road, and obtain the colors corresponding to the preprocessed point cloud data;

In terms of for a grid in the set plane, determining the pixel value of the pixel in the base map of the road corresponding to the grid according to the average reflectivity of the point cloud projected to the grid, the processing unit 1101 is specifically configured to:

for a grid in the set plane, determine the pixel value of the pixel in the base map of the road corresponding to the grid according to the average reflectivity of the point cloud projected to the grid and the average color corresponding to the point cloud projected to the grid.

In a possible implementation mode, that the pixel set composed of the pixels in the base map that road markings include is determined according to the base map is performed by a neural network. The neural network is trained with the sample base map marked with the road marking.

In a possible implementation mode, the recognition apparatus 1100 may further include a training unit 1103.

The training unit 1103 is configured to train the neural network, and is specifically configured to:

use the neural network to extract the features of the sample block base map to obtain the feature map of the sample block base map;

determine the probability that each pixel in the sample block base map belongs to the road marking based on the feature map of the sample block base map;

determine the n-dimensional feature vector of each pixel whose probability is greater than the preset probability value in the sample block base map according to the feature map of the sample block base map, the n-dimensional feature vector being used to represent the instance feature of the road marking, and n being an integer greater than 1;

cluster the pixels whose probability is greater than the preset probability value in the sample block base map according to the determined n-dimensional feature vector of the pixel, and determine the pixels belonging to the same road marking in the sample block base map; and

adjust the network parameter value of the neural network according to the determined pixels belonging to each road marking in the sample block base map and the road marking marked in the sample block base map.

In a possible implementation mode, the training unit 1103 is further configured to:

determine the marked distance of the first pixel in the sample block base map, the first pixel being any pixel in the sample block base map, the marked distance of the first pixel being the distance between the first pixel and the second pixel, the second pixel being the pixel with the minimum distance from the first pixel in the pixels that are in the road marking marked in the sample block base map;

in terms of adjusting the network parameter value of the neural network according to the determined pixels belonging to each road marking in the sample block base map and the road marking marked in the sample block base map, the training unit is specifically configured to:

adjust the network parameter value of the neural network according to the determined pixels belonging to each road marking in the sample block base map, the road marking marked in the sample block base map, the marked distance of the first pixel in the sample block base map and the predicted distance of the first pixel in the sample block base map; and

the predicted distance of the first pixel is the distance between the first pixel and the third pixel, and the third pixel is the pixel with the minimum distance from the first pixel in the determined pixels belonging to each road marking in the sample block base map.

In a possible implementation mode, the training unit 1103 is further configured to:

determine the marked direction of the fourth pixel in the sample block base map, the fourth pixel being any pixel in the sample block base map, the marked direction of the fourth pixel being the tangent direction of the fifth pixel, the fifth pixel being the pixel with the minimum distance from the fourth pixel in the pixels that are in the road marking marked in the sample block base map;

in terms of adjusting the network parameter value of the neural network according to the determined pixels belonging to each road marking in the sample block base map and the road marking marked in the sample block base map, the training unit is specifically configured to:

adjust the network parameter value of the neural network according to the determined pixels belonging to each road marking in the sample block base map, the road marking marked in the sample block base map, the marked direction of the fourth pixel in the sample block base map and the predicted direction of the fourth pixel in the sample block base map;

the predicted direction of the fourth pixel is the tangent direction of the sixth pixel, and the sixth pixel is the pixel with the minimum distance from the fourth pixel in the determined pixels belonging to each road marking in the sample block base map.

FIG. 12 is a block diagram of function units of a map generation apparatus provided by an embodiment of the application. The map generation apparatus 1200 may include a determining unit 1201 and a generating unit 1202.

The determining unit 1201 is configured to determine at least one road marking on the road according to the point cloud data of the road which is acquired by the intelligent driving device.

The generating unit 1202 is configured to generate the map including at least one road marking on the road according to at least one road marking on the road.

In a possible implementation mode, the map generation apparatus 1200 may further include a correcting unit 1203. The correcting unit 1203 is configured to correct the generated map and obtain the corrected map.

In a possible implementation mode, the map generation apparatus 1200 may further include a training unit 1204. The at least one road marking is determined by the neural network. The training unit 1204 is configured to train the neural network by using the generated map.

The embodiments of the application also provide an intelligent driving device, which may include the map generation apparatus provided by the embodiments of the application and the main body of the intelligent driving device. When the intelligent driving device is an intelligent vehicle, that is, the main body of the intelligent driving device is the main body of the intelligent vehicle, the intelligent vehicle is integrated with the map generation apparatus provided in the embodiments of the application.

The embodiments of the application also provide a computer storage medium, which stores a computer program. The computer program is executed by the processor to implement the part or all of the steps of any road marking recognition method recorded in the method embodiment, or the part or all of the steps of any map generation method recorded in the method embodiment.

The embodiments of the application also provide a computer program product, which includes a non-transitory computer readable storage medium that stores a computer program. The computer program may be executed to enable a computer to execute the part or all of the steps of any road marking recognition method recorded in the method embodiment, or the part or all of the steps of any map generation method recorded in the method embodiment.

It is to be noted that, for simple description, each method embodiment is expressed into a combination of a series of actions. However, those of ordinary skill in the art should know that the application is not limited by an action sequence described herein because some steps may be executed in another sequence or at the same time according to the application. Second, those of ordinary skill in the art should also know that the embodiments described in the specification all belong to optional embodiments and involved actions and modules are not always necessary to the application.

Each embodiment in the abovementioned embodiments is described with different emphases, and un-detailed parts in a certain embodiment may refer to related descriptions in the other embodiments.

In some embodiments provided by the application, it is to be understood that the disclosed device may be implemented in another manner. For example, the device embodiment described above is only schematic, and for example, division of the units is only logic function division, and other division manners may be adopted during practical implementation. For example, multiple units or components may be combined or integrated into another system, or some characteristics may be neglected or not executed. In addition, coupling or direct coupling or communication connection between each displayed or discussed component may be indirect coupling or communication connection, implemented through some interfaces, of the device or the units, and may be electrical or other forms.

The units described as separate parts may or may not be physically separated, and parts displayed as units may or may not be physical units, and namely may be located in the same place, or may also be distributed to multiple network units. Part or all of the units may be selected to achieve the purpose of the solutions of the embodiments according to a practical requirement.

In addition, each functional unit in each embodiment of the application may be integrated into a processing unit, each unit may also physically exist independently, and two or more than two units may also be integrated into a unit. The integrated unit may be realized in form of hardware or in form of software program module.

When being implemented in form of software program module and sold or used as an independent product, the integrated unit may be stored in a computer-readable memory. Based on this understanding, the technical solution of the application substantially or the part making a contribution to the conventional art can be embodied in the form of software product; the computer software product is stored in a memory, and includes a number of instructions to make a computer device (which may be a personal computer, a server or a network device, etc.) perform all or part of steps of the method in each embodiment of the present application. The abovementioned memory includes: various media capable of storing program codes such as a U disk, a Read-Only Memory (ROM), a Random Access Memory (RAM), a mobile hard disk, a magnetic disk or an optical disk.

Those of ordinary skill in the art can understand that all or part of the steps in various methods of the embodiments may be completed by related hardware instructed by a program, the program may be stored in a computer-readable memory, and the memory may include a flash disk, a ROM, a RAM, a magnetic disk, an optical disk or the like.

The embodiments of the application are introduced above in detail, the principle and implementation modes of the application are elaborated with specific examples in the application, and the descriptions made to the embodiments are only adopted to help the method of the application and the core concept thereof to be understood. In addition, those of ordinary skill in the art may make variations to the specific implementation modes according to the concept of the application. From the above, the contents of the specification should not be understood as limits to the application.

What is claimed is:

1. A road marking recognition method, comprising:
determining a base map of a road according to acquired point cloud data of the road, wherein pixels in the base map are determined according to reflectivity information of an acquired point cloud and position information of the point cloud;
determining a pixel set composed of the pixels in the base map that road markings comprise according to the base map; and
determining at least one road marking according to the determined pixel set.

2. The method as claimed in claim 1, wherein:
before determining the pixel set composed of the pixels in the base map that road markings comprise according to the base map, the method further comprises:
segmenting the base map of the road into multiple block base maps according to a topological line of the road;
determining the pixel set composed of the pixels in the base map that road markings comprise according to the base map comprises:
determining the pixel set composed of the pixels in the block base map which relate to road markings, according to each of the multiple block base maps.

3. The method as claimed in claim 2, wherein determining the pixel set composed of the pixels in the block base map that road markings comprise according to each of the multiple block base maps comprises:
rotating each block base map respectively; and
determining the pixel set composed of the pixels in each un-rotated block base map that road markings comprise according to each rotated block base map.

4. The method as claimed in claim 3, wherein:
rotating each block base map respectively comprises:
determining a transformation matrix corresponding to each block base map according to an included angle between the segmentation line of each block base map and the horizontal direction; and
according to the transformation matrix corresponding to each block base map, rotating each block base map until its segmentation line is consistent with the horizontal direction, wherein the segmentation line of a block base map is a straight line along which the block base map is segmented from the base map of the road;
determining the pixel set composed of the pixels in each un-rotated block base map that road markings comprise according to each rotated block base map comprises:
determining an initial pixel set composed of the pixels in the rotated block base map that road markings comprise according to each rotated block base map; and
according to an inverse matrix of the transformation matrix corresponding to each un-rotated block base map, transforming the pixels in each rotated block base map that road markings comprise to obtain the pixel set composed of the pixels in each un-rotated block base map that road markings comprise.

5. The method as claimed in claim 2, wherein segmenting the base map of the road into multiple block base maps according to the topological line of the road comprises:
determining the topological line of the road according to a moving track of a device that acquires the point cloud data of the road; and
segmenting the base map of the road equidistantly into image blocks along the topological line of the road, to obtain the multiple block base maps; wherein:
two adjacent block base maps in the base map of the road have an overlapping part, a segmentation line along which the base map of the road is segmented is perpendicular to the topological line of the road, and the parts, at two sides of the topological line of the road, of each block base map have the equal width.

6. The method as claimed in claim 2, wherein determining at least one road marking according to the determined pixel set comprises:
merging the pixel sets composed of the pixels in the adjacent block base maps with the same pixels to obtain a merged pixel set, wherein when the same pixel has multiple probabilities in the merged pixel set, the average of multiple probabilities of the same pixel is assigned as the probability of the pixel; and
determining at least one road marking according to the merged pixel set.

7. The method as claimed in claim 6, wherein:
determining the pixel set composed of the pixels in the block base map that road markings comprise according to each block base map comprises:
determining the probability that each pixel in each block base map belongs to the road marking according to a feature map of each block base map;
according to the feature map of each block base map, determining a n-dimensional feature vector of each pixel whose probability is greater than a preset probability value in each block base map; and
according to the n-dimensional feature vector of each pixel whose probability is greater than the preset probability value in the feature map of each block base map, clustering each pixel whose probability is greater than the preset probability value to obtain the pixel sets corresponding to different road markings in each block base map;
merging the pixel sets composed of the pixels in the adjacent block base maps with the same pixels to obtain the merged pixel set comprises:
when the pixel sets corresponding to the same road marking in the adjacent block base maps have the same pixels, merging the pixel sets corresponding to the same road marking in the adjacent block base maps, to obtain the pixel sets corresponding to the different road markings in the base map of the road;
determining at least one road marking according to the merged pixel set comprises:
determining each road marking according to the pixel set corresponding to each road marking; wherein:
determining each road marking according to the pixel set corresponding to each road marking comprises:
for a road marking, determining a key point that corresponds to the pixel set corresponding to the road marking according to the pixel set corresponding to the road marking; and
fitting the road marking based on the determined key point.

8. The method as claimed in claim 7, wherein:
determining that key point that corresponds to the pixel set corresponding to the road marking according to the pixel set corresponding to the road marking comprises:
determining a main direction of a first set by taking the pixel set corresponding to the road marking as the first set;
determining a rotation matrix according to the determined main direction of the first set;
according to the determined rotation matrix, transforming the pixels in the first set, so that the main direction of the first set after the pixel is transformed is the horizontal direction;
determining multiple key points according to the first set whose main direction is transformed;
fitting the road marking based on the determined key point comprises:
transforming the determined multiple key points based on the inverse matrix of the rotation matrix;
fitting a line segment corresponding to the first set based on the transformed multiple key points; and
taking the line segment corresponding to the first set as the road marking.

9. The method as claimed in claim 8, wherein when there are multiple pixel sets corresponding to one road marking, one of the pixel sets corresponding to the road marking is assigned as a first set, and the fitted line segments corresponding the first sets are unconnected, and wherein the method further comprises:
when there are unconnected line segments in the line segments corresponding to the first sets, when the distance between two endpoints with the smallest distance in unconnected two line segments is less than a distance threshold, and the endpoints of the unconnected two line segments are collinear, connecting the unconnected two line segments to obtain a spliced line segment; and
taking the spliced line segment as the road marking.

10. The method as claimed in claim 8, wherein determining multiple key points according to the first set whose main direction is transformed comprises:
taking the first set whose main direction is transformed as a set to be processed;
determining a leftmost pixel and a rightmost pixel in the set to be processed;
when an interval length is less than or equal to a first threshold and an average distance is less than a second threshold, determining a key point based on the leftmost pixel, and determining a key point based on the rightmost pixel; wherein the average distance is an average of the distances between the pixels in the set to be processed and the line segment formed by the leftmost pixel and the rightmost pixel, and the interval length is a difference between the abscissa of the rightmost pixel and the abscissa of the leftmost pixel in the set to be processed; and
when the interval length is less than or equal to the first threshold, and the average distance is greater than the second threshold, discarding the pixels in the set to be processed.

11. The method as claimed in claim 10, further comprising:
when the interval length is greater than the first threshold, taking the average of the abscissas of the pixels in the set to be processed as a segment coordinate;
taking the set composed of the pixels, whose abscissas are less than or equal to the segment coordinate, in the set to be processed as a first subset, and taking the set composed of the pixels, whose abscissas are greater than or equal to the segment coordinate, in the set to be processed as a second subset; and
taking the first subset and the second subset respectively as the set to be processed, performing the step of processing the set to be processed.

12. The method as claimed in claim 1, wherein determining the base map of the road according to the acquired point cloud data of the road comprises:
recognizing and removing a non-road point cloud from the acquired point cloud data of the road, and obtaining preprocessed point cloud data;
according to an attitude of the device that acquires the point cloud data of the road, transforming the preprocessed point cloud data of each frame into the world coordinate system, and obtaining the transformed point cloud data of each frame;
splicing the transformed point cloud data of each frame to obtain the spliced point cloud data;
projecting the spliced point cloud data to a set plane, the set plane being provided with grids divided according to a fixed length-width resolution, and each grid corresponding to a pixel in the base map of the road; and
for a grid in the set plane, determining a pixel value of the pixel in the base map of the road corresponding to the grid according to the average reflectivity of the point cloud projected to the grid.

13. The method as claimed in claim 12, wherein for a grid in the set plane, determining the pixel value of the pixel in the base map of the road corresponding to the grid according to the average reflectivity of the point cloud projected to the grid comprises:
for a grid in the set plane, determining a pixel value of the pixel in the base map of the road corresponding to the grid according to the average reflectivity and the average height of the point cloud projected to the grid.

14. The method as claimed in claim 12, wherein:
after obtaining the preprocessed point cloud data, the method further comprises:
according to an external reference of the device that acquires the point cloud data of the road to the device that acquires an image of the road, projecting the preprocessed point cloud data onto the acquired image of the road, and obtaining colors corresponding to the preprocessed point cloud data;
for a grid in the set plane, determining the pixel value of the pixel in the base map of the road corresponding to the grid according to the average reflectivity of the point cloud projected to the grid comprises:
for a grid in the set plane, determining the pixel value of the pixel in the base map of the road corresponding to the grid according to the average reflectivity of the point cloud projected to the grid and the average color corresponding to the point cloud projected to the grid.

15. The method as claimed in claim 1, wherein determining, according to the base map, the pixel set composed of the pixels in the base map that road markings comprise is performed by a neural network, and the neural network is trained with a sample base map marked with the road marking, wherein:
the neural network is trained by:
extracting features of a sample block base map by using the neural network to obtain the feature map of the sample block base map;
determining the probability that each pixel in the sample block base map belongs to the road marking based on the feature map of the sample block base map;
determining the n-dimensional feature vector of each pixel whose probability is greater than the preset probability value in the sample block base map according to the feature map of the sample block base map, wherein the n-dimensional feature vector is used to represent an instance feature of the road marking, and n is an integer greater than 1;
clustering the pixels whose probability is greater than the preset probability value in the sample block base map according to the determined n-dimensional feature vector of the pixel, and determining the pixels belonging to the same road marking in the sample block base map; and
adjusting a network parameter value of the neural network according to the determined pixels belonging to each road marking in the sample block base map and the road marking marked in the sample block base map.

16. A map generation method, comprising:
using the method as claimed in claim 1 to determine the at least one road marking on a road according to point cloud data of the road which is acquired by an intelligent driving device;
generating a map including the at least one road marking on the road, according to the at least one road marking on the road; and
correcting the generated map and obtaining a corrected map, wherein:
the at least one road marking is determined by a neural network;
after generating the map, the method further comprises:
training the neural network by using the generated map.

17. An electronic device, comprising:
at least one processor; and
a non-transitory computer readable storage, coupled to the at least one processor and storing at least one computer executable instruction thereon which, when executed by the at least one processor, causes the at least one processor to:
determine a base map of a road according to acquired point cloud data of the road, wherein pixels in the base map are determined according to reflectivity information of an acquired point cloud and position information of the point cloud;
determine a pixel set composed of the pixels in the base map that road markings comprise according to the base map; and
determine at least one road marking according to the determined pixel set.

18. A map generation apparatus, comprising:
at least one processor; and
a non-transitory computer readable storage, coupled to the at least one processor and storing at least one computer executable instruction thereon which, when executed by the at least one processor, causes the at least one processor to:
use the method as claimed in claim 1 to determine at least one road marking on a road according to point cloud data of the road which is acquired by an intelligent driving device;
generate a map including the at least one road marking on the road according to the at least one road marking on the road; and
correct the generated map and obtaining a corrected map, wherein:
the at least one road marking is determined by a neural network;
the at least one computer executable instruction when executed by the at least one processor, further causes the at least one processor to:
train the neural network by using the generated map after generating the map.

19. An intelligent driving device, comprising the map generation apparatus as claimed in claim 18 and a main body of the intelligent driving device.

20. A non-transitory computer readable storage medium storing computer programs which, when executed by a processor, cause the processor to:
determine a base map of a road according to acquired point cloud data of the road, pixels in the base map being determined according to reflectivity information of an acquired point cloud and position information of the point cloud;
determine a pixel set composed of the pixels in the base map that road markings comprise according to the base map; and
determine at least one road marking according to the determined pixel set.
